(19) United States
(12) Patent Application Publication
(10) Pub. No.: US 2020/0236359 A1
(43) Pub. Date: Jul. 23, 2020

(54) APPARATUS AND METHOD FOR IMAGE CODING WITH BOUNDARY PARTITION PROCESSING

(71) Applicant: Huawei Technologies Co., Ltd., Shenzhen (CN)

(72) Inventors: Han GAO, Munich (DE); Zhijie ZHAO, Munich (DE); Semih ESENLIK, Munich (DE); Anand Meher KOTRA, Munich (DE); Shan LIU, Munich (DE)

(21) Appl. No.: 16/844,796

(22) Filed: Apr. 9, 2020

Related U.S. Application Data
(63) Continuation of application No. PCT/EP2017/075709, filed on Oct. 9, 2017.

(51) Int. Cl. H04N 19/119; H04N 19/96; H04N 19/30; H04N 19/46; H04N 19/172

(52) U.S. Cl. CPC H04N 19/119; H04N 19/96; H04N 19/172; H04N 19/46; H04N 19/30

(57) ABSTRACT

An apparatus and a method for image coding with boundary partitioning processing are disclosed. In image coding, and particularly in video coding, images are typically split into smaller blocks or units that are then processed. Effective splitting or partitioning has an important role in effective image coding. The apparatus and method use a particular boundary partitioning processing for improving splitting, which can be used in improving compression performance. The boundary partitioning reduces unnecessary partitioning on the frame boundary and reduces complexity of a forced partitioning procedure.

### CROSS-REFERENCE TO RELATED APPLICATIONS

This application is a continuation of International Application No. PCT/EP2017/075709, filed on Oct. 9, 2017. The aforementioned application is hereby incorporated by reference in its entirety.

### TECHNICAL FIELD

The present disclosure relates to the field of image coding. Particularly, the disclosure relates to improving coding and decoding of a video with boundary forced partitioning.

### BACKGROUND

Digital video has been widely used since introduction of DVD-discs. Before transmission the video is encoded and transmitted using transmission medium. The viewer receives the video and uses a viewing device to decode and display the video. Over the years the quality of video has improved, for example, because of higher resolutions, color depths and frame rates. This has lead into larger data streams that are nowadays commonly transported over internet and mobile communication networks.

Higher resolution videos, however, typically require more bandwidth as they have more information. In order to reduce the bandwidth requirement video coding standards involving compression of the video have been introduced. When the video is encoded the space requirement is reduced. Often this reduction comes at the cost of quality. Thus, the video coding standards try to find a balance between the bandwidth requirement and the quality.

As video involves a sequence of images results may be achieved also by treating individual images better. Thus, some methods and technologies can be used both in video and individual image processing.

As there is a continuous need for improving quality and reducing space requirement, solutions that maintain the quality with reduced space requirement or improve the quality while maintaining the space requirement are continuously searched. Furthermore, sometimes compromises may be accepted. For example, it may be acceptable to increase the space requirement if the quality improvement is significant.

The High Efficiency Video Coding (HEVC) is an example of a video coding standard that is commonly known to persons skilled in the art. In HEVC, to split a coding unit (CU) into prediction units (PU), eight different partition modes are supported. In addition to the symmetric partitioning modes, four asymmetric partitioning (AMP) modes are supported. These subdivide the CU into two rectangular PUs of different sizes. One of the resulting PUs has a rectangular shape with one side having a length equal to the width and height M of the CU and the other side having a length equal to M/4; the other PU covers the remaining rectangular area of the CU. The asymmetric partitioning modes are only supported for CU sizes larger than 8×8 luma samples.

In HEVC, a coding tree unit (CTU) is split into coding units (CU) by using a quadtree structure denoted as coding tree to adapt to various local characteristics. For small CTU size setting and low resolution sequences, the quad tree approach may be able to make the boundary CTU treatable without introducing too many unnecessary partitions. A boundary CTU is the largest Coding Unit located on a slice/picture boundary. However, for HD or higher resolution and larger CTU configuration unnecessary boundary forced partition happens quite often by using forced QT structure. This typically leads into higher bitrate.

### SUMMARY

An apparatus and a method for image coding with boundary partitioning processing are disclosed. In image coding, and particularly in video coding, images are typically split into smaller blocks or units that are then processed. Effective splitting or partitioning has an important role in effective image coding. The apparatus and method use a particular boundary partitioning processing for improving splitting, which can be used in improving compression performance. The boundary partitioning reduces unnecessary partitioning on the frame boundary and reduces complexity of forced partitioning procedure.

In an aspect, an image coding apparatus is disclosed. The image coding apparatus in configured to determine if a coding unit of an image is located on an image boundary. In case the coding unit is located on the image boundary, the apparatus is further configured to determine whether the image boundary divides the coding unit into two portions having different sizes or equal sizes; perform a boundary partition processing on the coding unit, wherein the boundary partition processing comprises triple tree partitioning or asymmetric partitioning if the image boundary divides the coding unit into two portions having different sizes; and perform a symmetric binary tree partition if the image boundary divides the coding unit into two portions having equal sizes.

The apparatus according to the aspect provides an efficient image partitioning by maintaining the divided partitions as large as possible. Furthermore, the apparatus provides an effective way to end the partitioning by using binary partitioning when the coding unit or the coding tree unit can be split into two partitions of equal size.

In an implementation of the aspect, the apparatus is further configured to hierarchically repeat partitioning on child coding units, which are located on the image boundary, partitioned from the coding unit until a deepest level coding unit is entirely inside the image boundary. The hierarchically repeating the partitioning facilitates the normal partitioning as the coding units are entirely inside the image boundary.

In an implementation of the aspect the first partitioned coding unit is a coding tree unit. The partitioning starts from a coding tree unit and proceeds into coding units that may be further partitioned.

In an implementation of the aspect, the apparatus is further configured to perform N shallowest levels quad tree partitioning after determining if a coding tree unit is located on the image boundary, wherein N is an integer smaller than the number of partitioning hierarchy levels. The use of N shallowest levels quad tree partition provides possibility to use efficient quad tree partitioning together with earlier discussed implementations of the aspect.

In an implementation of the aspect, the apparatus is further configured to use a predefined N shallowest level of quad tree partitions or derive N shallowest level of quad tree partitions using a predefined method. The implementation provides the possibility to other use quad tree partition implementations without additional signaling in the bitstream. This provides the possibility to improve the coding efficiency.

In an implementation of the aspect, the apparatus is further configured to limit the aspect ratio of a current leaf node of the coding units as a criteria for partition direction when the aspect ratio exceeds a threshold value. A current leaf node is a coding unit currently being processed or current coding unit. This implementation increases freedom for the normal partitioning so that the partition can be limited by aspect ratio of the current leaf node.

In an implementation of the aspect, the apparatus is further configured to use as the threshold value a predefined threshold or derive the threshold using a predefined method. The implementation provides the possibility to other use aspect ratio implementations for determining partition type or direction without additional signaling in the bitstream.

In an implementation of the aspect, the apparatus is further configured to use quad-tree partitioning in each hierarchy level for a corner boundary. This provides possibility to treat corner boundary in effective way and allows the efficient treating for other parts of the horizontal and vertical boundary.

In an implementation of the aspect, the apparatus is an image encoding apparatus, and the image encoding apparatus is further configured to generate a bitstream including the coded coding units and a partitioning information indicating how the coding tree units are partitioned. This provides a possibility to produce a bitstream with efficient further partitioning and the partitioning information can be achieved at the decoder side.

In an implementation of the aspect, the apparatus is further configured to further partition the deepest level boundary coding unit according to rate-distortion optimization. This provides the possibility to utilize the rate distortion optimization for the further partitions which are split from the deepest coding unit on boundary based on the apparatus mentioned before In other words as soon as a coding unit is entirely within the image boundary further partitioning of said block may be done based on Rate Distortion (RD) optimization. This increases partitioning possibility.

In an implementation of the aspect, the apparatus is a decoding apparatus. This provides the possibility of decoding the encoded images so that they can be shown to viewers.

In an implementation of the aspect, the decoding apparatus is further configured to parse a bitstream including coded coding units and a partitioning information indicating how the coding tree units are partitioned. This provides the possibility to derive the partitioning information from the received bitstream that is being decoded.

In an implementation of the aspect, an indication of the N shallowest levels of quad tree partitions or the threshold of the aspect ratio is included in the partitioning information of the image. These information could be signaled in sequence level through sequence parameter set, in picture level through picture parameter set, or in slice level through slice header, or in CTU level through. This provides the possibility to use N shallowest levels of the quad tree or the threshold without making an agreement on it or on a method for deriving at least one of these. In the encoder side this information will be encoded to the bitstream being encoded. In the decoder side this will be parsed and decoded from the decoded bitstream.

In an aspect, a method for coding an image is disclosed. The method comprises determining if a coding unit of an image is located on an image boundary. In case the coding unit is located on the image boundary the to the method further comprises: determining whether the image boundary divides the coding unit into two portions having different sizes or equal sizes; performing a boundary partition processing on the coding unit, wherein the boundary partition processing comprises triple tree partitioning or asymmetric partitioning if the image boundary divides the coding unit into two portions having different sizes; and performing a symmetric binary tree partition if the image boundary divides the coding unit into two portions having equal sizes.

The method according to the aspect provides an efficient image partitioning by maintaining the divided partitions as large as possible. Furthermore, the apparatus provides an effective way to end the partitioning by using binary partitioning when the coding unit or the coding tree unit can be split into two partitions of equal size.

In an implementation, the method further comprises hierarchically repeating partitioning on child coding units, which are located on the image boundary, partitioned from the coding unit until a deepest level coding unit is entirely inside the image boundary. The hierarchically repeating the partitioning facilitates the normal partitioning as the coding units are entirely inside the image boundary.

In an implementation, the method the first partitioned coding unit is a coding tree unit. The partitioning starts from a coding tree unit and proceeds into coding units that may be further partitioned.

In an implementation, the method further comprises performing N shallowest levels quad tree partitioning after determining if a coding tree unit is located on the image boundary, wherein N is an integer smaller than the number of partitioning hierarchy levels. The use of N shallowest levels quad tree partition provides possibility to use efficient quad tree partitioning together with earlier discussed implementations of the aspect.

In an implementation, the method further comprises limiting the aspect ratio of the current leaf node of the coding unit as a criteria for partition direction when the aspect ratio exceeds a threshold value. This implementation increases freedom for the normal partitioning so that the partition can be limited by aspect ratio of the current leaf node.

In an aspect, the method described above is implemented as a computer program comprising computer program code that causes the method to be performed when the computer program is executed on a computing device. It is particularly beneficial to implement the method as a computer program as it can easily be executed in different computing devices.

The aspects and implementations disclosed above are beneficial in general as they may be used in improving the image, particularly video, encoding and decoding efficiency and/or quality. This provides better use of capacity of existing devices and the user experience can be improved.

### BRIEF DESCRIPTION OF THE DRAWINGS

The present description will be better understood from the following detailed description read in light of the accompanying drawings, wherein:

FIG. 1 is an illustration of an example of a video encoding apparatus;

FIG. 2 is an illustration an example of a video decoding apparatus;

FIG. 3 is an illustration of an example method involving boundary partitioning processing;

FIG. 4 is an illustration of another example method involving boundary partitioning processing;

FIG. 5 is an illustration of HD sequence (1920×1080) bottom boundary CTU (128×128) forced partition;

FIG. 6 is an illustration of HD sequences bottom boundary CTU forced BT partition;

FIG. 7 is an illustration of bottom boundary processing with a CTU forced TT partition;

FIG. 8 is an illustration of a bottom boundary CTU forced AMP partition;

FIG. 9 is an illustration of a bottom boundary CTU forced QT+forced TT partition; and

FIG. 10 is an illustration of a forced TT for HD bottom boundary partition with limited aspect ratio 1:4

### DETAILED DESCRIPTION

In the following description, reference is made to the accompanying drawings, which form part of the disclosure, and in which are shown, by way of illustration, specific aspects in which the present invention may be placed. It is understood that other aspects may be utilized and structural or logical changes may be made without departing from the scope of the present invention. The following detailed description, therefore, is not to be taken in a limiting sense.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various exemplary aspects described herein may be combined with each other, unless specifically noted otherwise.

Video coding typically refers to the processing of a sequence of pictures, which form the video or video sequence. The term picture, image or frame may be used/are used synonymously in the field of video coding as well as in this application. Each picture is typically partitioned into a set of non-overlapping blocks. The encoding/decoding of the picture is typically performed on a block level where e.g. inter frame prediction or intra frame prediction are used to generate a prediction block, to subtract the prediction block from the current block (block currently processed/to be processed) to obtain a residual block, which is further transformed and quantized to reduce the amount of data to be transmitted (compression) whereas at the decoder side the inverse processing is applied to the encoded/compressed block to reconstruct the block (video block) for representation.

In the following boundary partitioning processing is disclosed in hybrid video coding or still image coding. However, the method discussed may be applied to individual pictures or images that need to be partitioned for other processing purposes. In the following boundary partition processing using triple tree (TT) or asymmetric partition (AMP) structure is disclosed. Instead of the conventional approach of forcing quad tree (QT), in the following, horizontal TT or AMP for bottom boundary and vertical TT or AMP for right boundary are introduced. For the right bottom corner boundary, forcing QT will be used until (1) the current CU on the image boundary does not need to be force partitioned, i.e. the CU is entirely within the boundary, (2) the current CU is only on the bottom boundary, or (3) the current CU is only on the right boundary. Triple tree and asymmetric partitioning are used in this description as examples only and may be replaced with other suitable partitioning schemes.

In the following description normal partition is used to mean non-forced rate distortion optimization based partitioning, where a partition flag is used in normal partition to indicate the partition type, such as a flag to indicate a horizontal binary tree partition, or a vertical binary tree partition, or a vertical triple tree partition, or a horizontal triple tree partition or any other supported partition types.

This arrangement has a benefit of providing possibility to maintain larger split block sizes until the remaining boundary samples in the current CU are exactly half of the block height/width. At this stage the binary partitioning can be used to terminate the partitioning processing.

In general, instead of forcing QT, boundary partition processing with TT or AMP may be first used to obtain the largest possible split CU of the boundary samples until all samples are inside of the frame boundary, or remaining boundary samples in current CU are exactly half of the block height/width, then BT is used to terminate the forced partition processing.

In another disclosed example a combination of forced QT and boundary partitioning processing is shown. Boundary partitioning processing is performed only after a certain number of QT partitioning levels. This is for instance advantageous in cases where the further partitioning after forced partitioning is limited according to a predefined configuration. For instance further partitioning of the current leaf node may be limited by a predefined maximal or minimal TT or AMP size, the maximal TT or AMP depth, etc. This allows to obtain a finer partition of the CU. For the combination of QT and boundary partitioning processing, the levels of QT could be predefined or adaptive selected in both encoder and decoder side using same method. It could also be adjusted by cost and signaled into the bitstream to indicate how many levels of forced QT are used for the decoder.

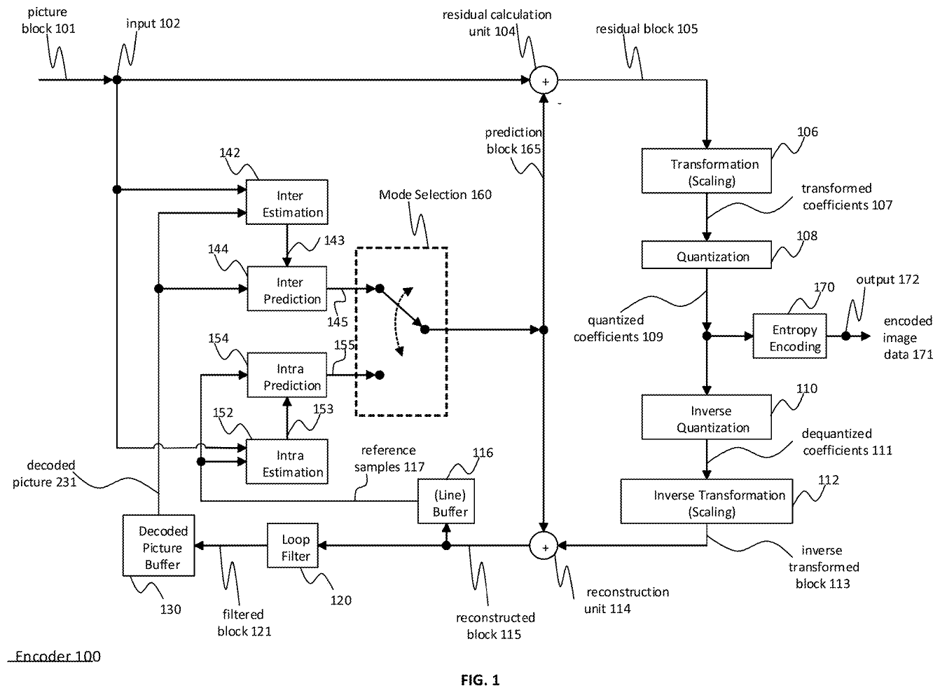

FIG. 1 shows an encoder 100, which comprises an input 102, a residual calculation unit 104, a transformation unit 106, a quantization unit 108, an inverse quantization unit 110, and inverse transformation unit 112, a reconstruction unit 114, a buffer 116, a loop filter 120, a frame buffer 130, an inter estimation unit 142, an inter prediction unit 144, an intra estimation unit 152, an intra prediction unit 154, a mode selection unit 160, an entropy encoding unit 170, and an output 172.

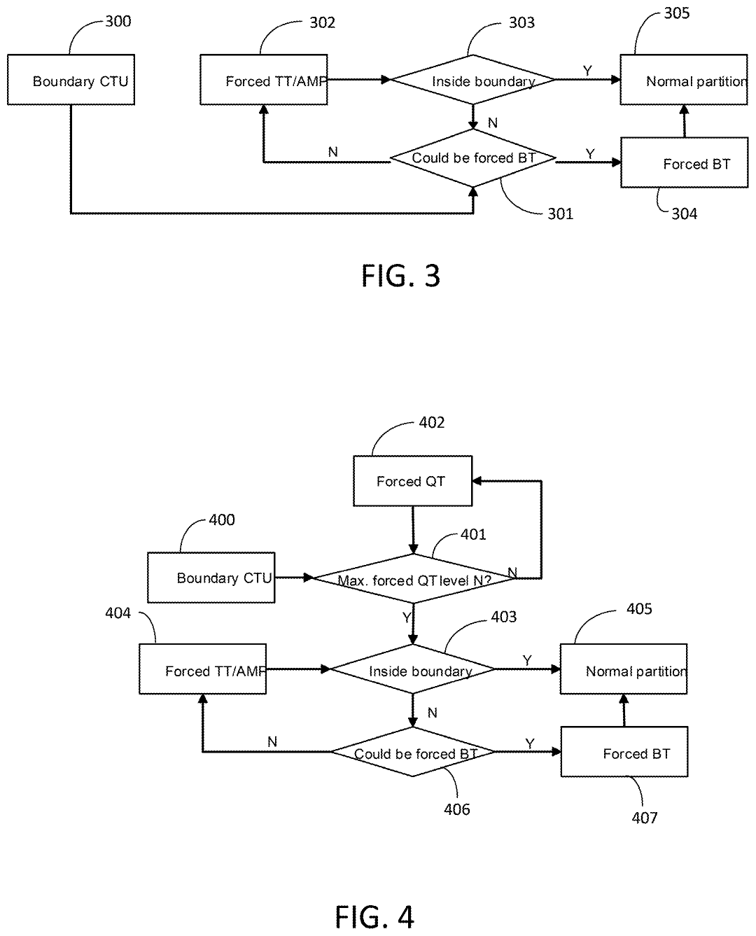

In the following description, particularly with regard FIGS. 3 and 4, two example implementations are discussed. In the method according to FIG. 3, which will be described in detail in the following, a CU is force partitioned by applying the method described above until the CU is located entirely within the image boundary. At this point the forced partitioned CU may be further partitioned, sent to the input 102 and processed by the inter- or intra-processing blocks 142, 144, 154, 152 to obtain a RD value. The force partitioned CU may be further partitioned by using different partitioning schemes and the RD value is calculated. The CU with the smallest RD value will then be used to perform prediction.

In the implementation of FIG. 4, which will be described in detail in the following, the forced partitioning includes firstly performing one or more levels of QT partitioning. In an implementation the number of QT partitioning levels is predefined. Alternatively, the number of QT partitioning levels may be dynamically determined. For instance several forced partitioning loops, each including a different number of initial QT partitioning levels up a maximum threshold, are performed to obtain a corresponding partitioned CU. The at least one partitioned CU entirely lies within the image boundary and may be eventually further partitioned according to different partitioning schemes as described above with relation to FIG. 3. The so obtained CU is then processed by the Inter Estimation 142, Inter prediction 134, Intra prediction 154 or Intra estimation 152 to calculate an RD value and the partitioned CU with the smallest RD value is chosen for performing prediction. The maximum threshold may be calculated based on the size of the shorter edge within the image of the boundary CTU.

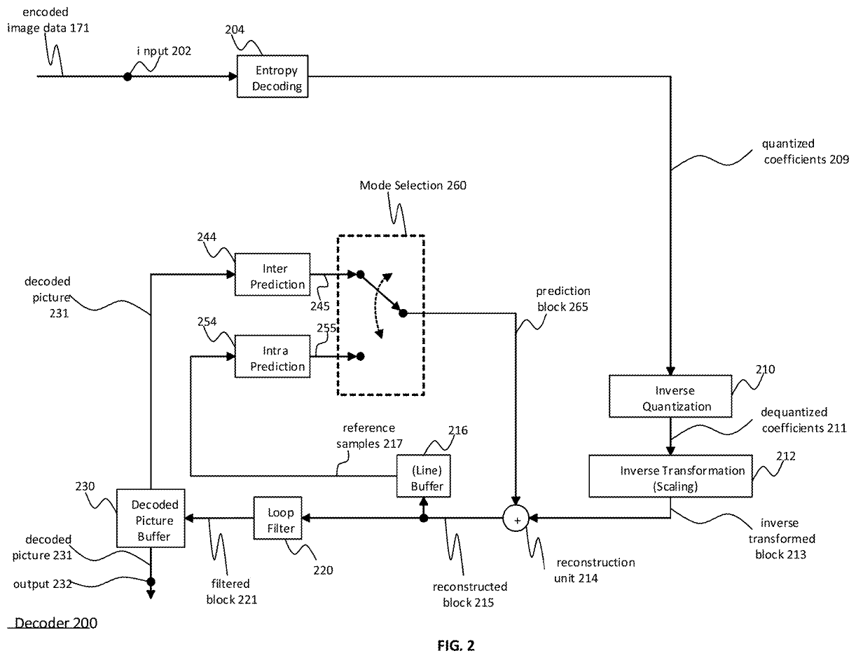

FIG. 2 shows an exemplary video decoder 200 configured to receive a encoded picture data (bitstream) 171, e.g. encoded by encoder 100, to obtain a decoded picture 231. The decoder 200 comprises an input 202, an entropy decoding unit 204, an inverse quantization unit 210, an inverse transformation unit 212, a reconstruction unit 214, a buffer 216, a loop filter unit 220, a decoded picture buffer 230, an inter prediction unit 244, an intra prediction unit 254, a mode selection unit 260 and an output 232.

With reference to FIG. 2 the decoder receives a bitstream from the encoder. Forced partitioning is executed based the force partitioning scheme, known at the decoder, as discussed before with reference to FIG. 3 until the partitioned CU is entirely within the image boundary. Thereafter at the entropy decoding unit 204 partitioning information concerning the further partitioning is parsed from the bitstream and the force partitioned CU is further partitioned according said parsed partitioning information. The obtained partitioned CU is then further processed by the inter-/intra prediction unit for performing prediction.

With reference to FIG. 4, the entropy decoding unit 204 may parse from the bitstream the number of initial forced QT partitions before executing the forced partitioning scheme known at the decoder. The method proceeds then as described in the above paragraph.

FIG. 3. is an illustration of an example method involving of boundary partition processing. In the method of FIG. 3 the method is initiated by determining if a coding tree unit of an image is located on an image boundary, step 300. In the example of FIG. 3 the determination is done for coding tree unit, however, this is only an example and the method may be initiated from a coding block that has been partitioned, split or other way derived from a coding tree unit. The boundary in the following description should be understood to be one of the following: horizontal boundary, vertical boundary or corner.

In the example of FIG. 3, as a response to the positive detection of a boundary coding tree unit, possibility to perform binary tree partitioning is checked, step 301. This may be done by determining whether the image boundary divides the coding unit into two portions having different or equal sizes. This, however, does not apply for corner cases, in which case additional forced QT partitioning is performed until the corner portion coding block is entirely inside the image boundary as will be explained in the following. If the two portions are of equal size, then symmetric binary tree partitioning is performed, step 301. If the two portions are of the equal size, the binary partitioning can be used to terminate the boundary forced partition processing and continue with normal partitioning, step 305.

If the two portions are of different size, boundary partition processing is initiated, step 302. In the FIG. 3 the boundary partition processing is one of the following: triple tree partitioning or asymmetric partitioning. These are explained in more detail below, however, other suitable partitioning methods may also be used.

After first boundary partition processing it is determined if the right boundary or bottom boundary sample of the current CTU/CU is located inside of the bottom image boundary or right image boundary. When it is inside, the method continues with normal partitioning, step 305. If it is not entirely inside, the method continues from step 301 by checking again the possibility to perform binary tree partitioning. Commonly the apparatus is configured to hierarchically repeat partitioning on child coding units, which are located on the image boundary, partitioned from the coding unit until a deepest level coding unit is entirely inside the image boundary.

FIG. 4 is an illustration of another example method involving boundary partitioning processing. The method of FIG. 4 starts correspondingly checking if the CTU or CU is on the image boundary as in the method of FIG. 3, step 400. If it is a boundary, first it is checked if a predetermined N shallowest levels quad tree partitioning have been performed, step 401. If not, then QT partitioning is performed at step 402, N being an integer smaller than the maximal number of forced partitioning hierarchy levels, here the maximal forced partition levels could be derived from the size of the shorter edge within the image of the boundary CTU. N may be predetermined, determined using a common method at encoder and decoder or provided in the bitstream. The common method may be a calculation based on temporal id, slice type, CTU size or similar. Typically the QT level N is integer number smaller than the maximal possible forced partition levels. It can be noted that if N is 0 the method simplifies to the example method shown in FIG. 3.

After QT partition the partitioning method proceeds with boundary partitioning processing similarly as in the example of FIG. 3. Thus, first it is checked if the CTU or CU is inside the image boundary, step 403 and if yes, the method proceeds to normal partitioning, step 405. If not, it is first checked if the image boundary divides the current CU into two equal size, which means a BT partition could be done, step 406. If yes, then the BT partitioning is done, step 407 and the method proceeds to normal partitioning, step 405. If no, the method is continued by triple tree or asymmetric partitioning, step 404.

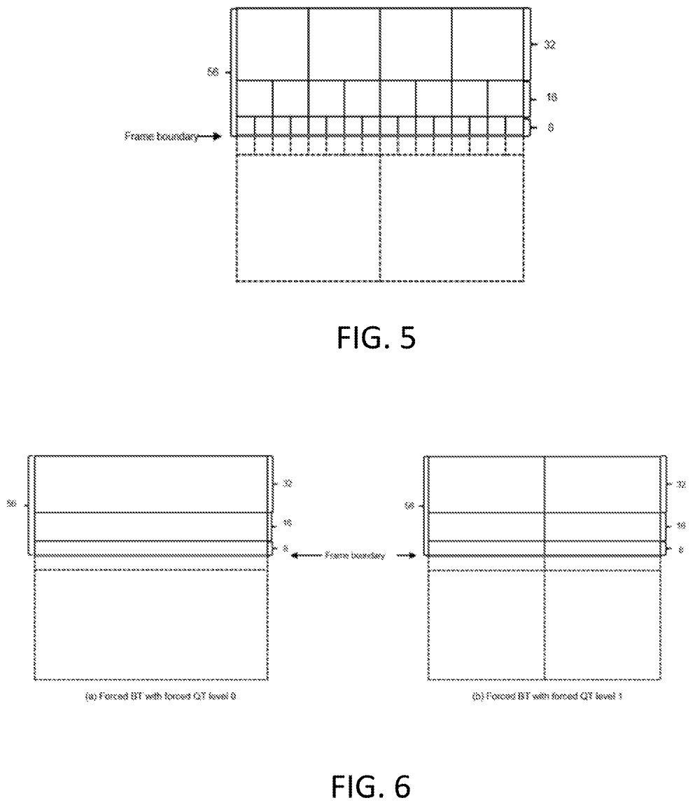

In FIGS. 5-10 the partitioning process is explained in view of the conventional approaches and the approaches proposed in current disclosure. FIG. 5 discloses is an illustration of HD sequence (1920×1080) bottom boundary CTU (128×128) forced partition. In the HEVC standard and JVET test model JEM 7.0, the coding tree units (CTU) or coding unit (CU), which is located on the slice/picture boundaries will be forced split using quadtree (QT) until the right bottom sample of the leaf node is located within the slice/picture boundary. The forced QT partition does not need to be signaled in the bitstream. The purpose of a forced partition is to make the boundary CTU/CU possible by the encoder/decoder.

In JEM 7.0, the boundary CTU/CU forced partition process is inherited from HEVC although quad-tree plus binary tree structure was introduced in JEM. Which means CTU/CU located on the slice/picture boundary is first forced partitioned by quadtree (QT) structure without rate-distortion (RD) optimization until the whole current CU lies (?) is located inside the slice/picture boundary. These forced partitions do not need to be signaled in the bitstream. Further partitions of the forced partitioned CUs are possibly achieved based on RD optimization, which needs to be signaled in the bitstream. FIG. 5 shows one forced partition example of the HD (1920×1080 pixels) sequence bottom boundary CTU (128×128) by a forced QT.

FIG. 6 is an illustration of HD sequences bottom boundary CTU forced BT partition. The forced BT partition (FIG. 6a) and a forced QT plus a forced BT partition (FIG. 6b) for the boundary CTUs are shown in FIG. 6. Instead of a forced QT partition, in the FIG. 6a forced BT approach, a forced horizontal BT for bottom boundary and a forced vertical BT for right boundary are used. For the right bottom corner boundary, a forced QT will be used until the current CU does not need to be force partitioned or the current CU is on the bottom or right boundary. Alternatively, the corner CTU/CU could be considered as either bottom boundary or right boundary CTU/CU. In addition, a forced BT can be combined with a forced QT partition as shown in FIG. 6b, wherein the forced BT partition is only done after a certain number of forced QT levels. For the combination of a forced QT and a forced BT partition, the levels of forced QT could be pre-defined or adaptive selected.

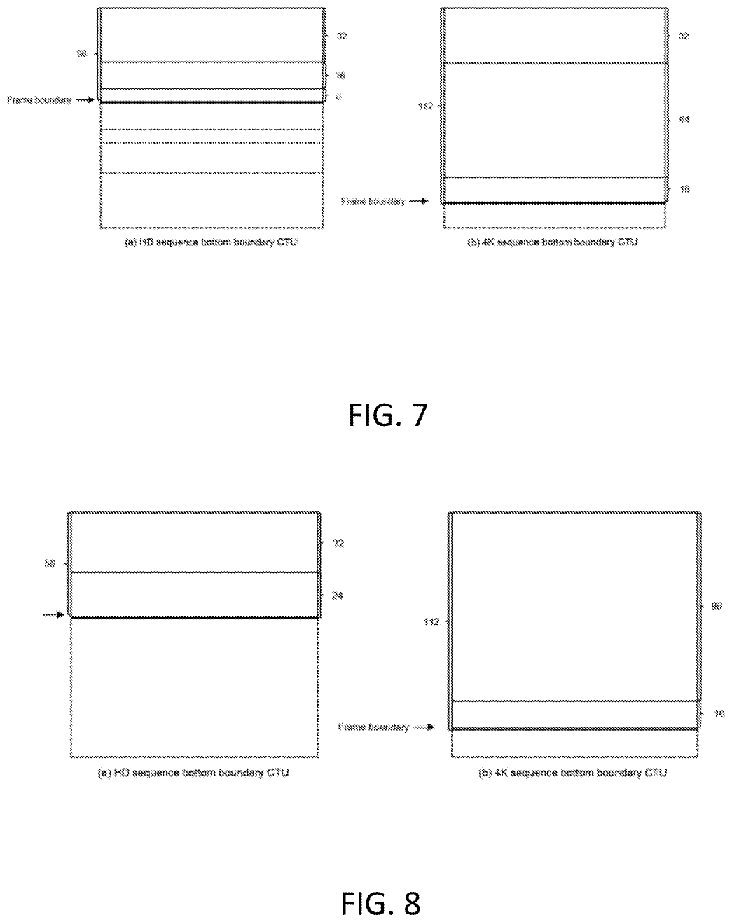

FIGS. 7 and 8 explain using triple tree and asymmetric partitioning in boundary partition processing. These two methods, or other corresponding methods, are optional to each other. Thus, the encoder and decoder should use the same method. This can be, for example, agreed in advance or signaled in the bitstream.

FIG. 7 is an illustration of bottom boundary processing with a CTU forced TT partition. FIG. 7 illustrates situations, wherein when the CTU/CU is located on the bottom boundary, horizontal forced TT is used without partition flag signaling at the encoder recursively until the boundary CU is entirely located within the slice/picture boundary. The forced horizontal TT partition is terminated when the deepest level coding unit is entirely inside the image boundary. In particular, the TT partition may be terminated in the following two cases: (a) When the right bottom sample of the boundary leaf nodes is located within the slice/picture bottom boundary, or (b) when height of the rest boundary samples within the slice/picture boundary in current CU is exactly half of the height of current boundary located CU, in the other words, the rest samples could be directly split by forced BT horizontally. In the (a) case, the forced partition is terminated, in the (b) case, after one step horizontal forced BT the forced partition is terminated.

After forced partition, forced TT with or without last forced BT step, the forced partitioned CUs from the boundary CTU are possibly further split based on RD-cost at the encoder and the further split flag is signaled from the encoder to the decoder. FIG. 7(a) shows the example of 128×56 samples bottom boundary (HD sequence bottom boundary CTU) partitioned by forced horizontal TT, in this case, no forced BT is applied to terminate the forced partition procedure. FIG. 7(b) shows the example of 128×112 samples bottom boundary (4K sequence bottom boundary CTU) partitioned by forced TT, in this case, forced BT in the last forced partition is applied.

Similarly, for the CTU/CU located on the right boundary, vertical forced TT partition is used without partition flag signaling at the encoder recursively until the right bottom sample of the boundary leaf nodes are located within the slice/picture right boundary or the rest samples in current boundary located CU could be directly split by forced BT vertically. After forced vertical TT (with or without forced BT) partition, the forced partitioned CUs from the boundary CTU are possibly further split by RD-optimization at the encoder and the further split flag is signaled from the encoder to the decoder.

For the right bottom corner boundary located CTU/CU, first the forced QT partition is used without signaling recursively. When the right bottom sample of the current CU is located on the bottom or right boundary, a further forced horizontal or vertical TT partition will be operated recursively until the right bottom samples of the boundary leaf nodes located inside of the slice/picture boundary or the rest samples in current CU could be directly split by a forced BT on the direction of forced partition. Otherwise, when the right bottom sample of the current boundary located CU is still located on the corner boundary, a further forced QT partition will be used until the right bottom samples of the boundary leaf nodes are within the slice/picture boundary. The forced partitioned CUs from the boundary CTU are possibly further split by RD-optimization at the encoder and the further split flag is signaled from the encoder to the decoder. FIG. 8 discloses similar arrangement with forced asymmetric partitioning (AMP). If the CTU/CU locates on the bottom boundary, forced bottom AMP will be applied recursively without any signaling until the boundary deepest level coding unit is entirely inside the slice/picture boundary. For example, forced bottom AMP will be recursively applied until the right bottom sample of the boundary leaf nodes located inside of the slice/picture bottom boundary or the rest samples of the current boundary located CU could be directly split by forced BT horizontally. The forced AMP should always keep the non-boundary forced partitioned CU as large as possible. After forced partition the forced split CUs from the boundary CTU are possibly further split based on RD-cost at the encoder and the further split flag is signaled from the encoder to the decoder. FIG. 8(a) shows the example of 128×56 samples bottom boundary (HD sequence bottom boundary CTU) partitioned by forced horizontal AMP. In this case, no forced BT is applied to terminate the forced partition procedure. FIG. 8(b) shows the example of 128×112 samples bottom boundary (4K sequence bottom boundary CTU) partitioned by forced TT. In this case, forced BT in the last forced partition is applied.

For the CTU/CU located on the right boundary, forced bottom AMP will be applied recursively without any signaling until, for instance, the right bottom sample of the boundary leaf nodes located inside of the slice/picture right boundary or the rest samples of the current boundary located CU could be directly split by forced BT on the direction of forced partition. The forced AMP should always keep the non-boundary forced partitioned CU as large as possible. After forced partition, the forced split CUs from the boundary CTU are possibly further split based on RD-cost at the encoder and the further split flag is signaled from the encoder to the decoder.

For the right bottom corner boundary located CTU/CU, first the forced QT partition is used without signaling it recursively. When the right bottom sample of the current CU is located on the bottom or right boundary, a further forced horizontal or vertical AMP partition will be operated recursively until the right bottom samples of the boundary leaf nodes located inside of the slice/picture boundary or the rest samples in current CU could be directly split by forced BT on the direction of forced partition. Otherwise, when the right bottom sample of the current boundary located CU is still located on the corner boundary, a further forced QT partition will be used until the right bottom samples of the leaf nodes within the slice/picture boundary. The forced partitioned CUs from the boundary CTU are possibly further split by RD-optimization at the encoder and the further split flag is signaled from the encoder to the decoder.

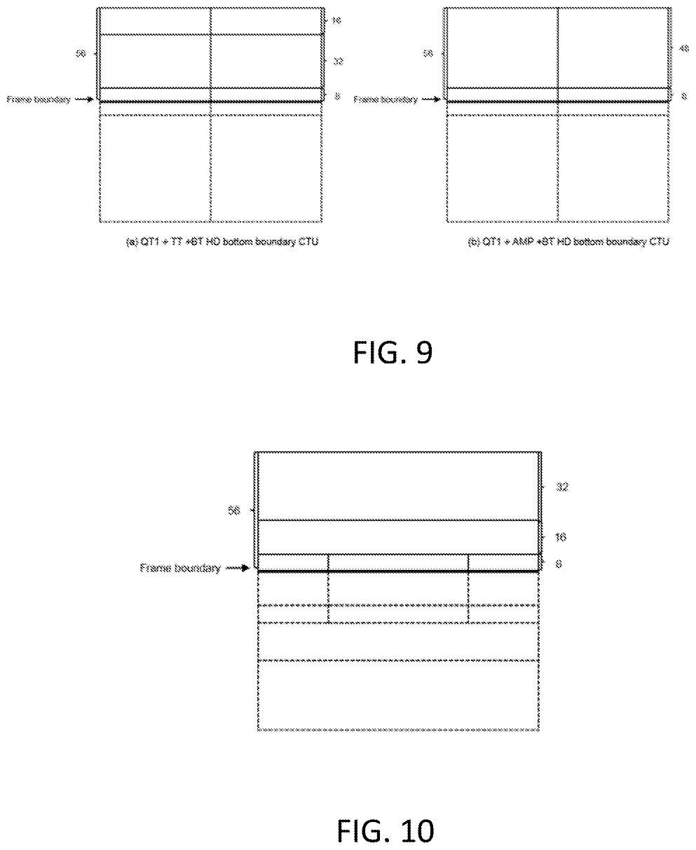

In FIG. 9 the combination of forced QT and forced TT/AMP (with or without last forced BT step) partition is shown. For some complex texture or motion on the boundary a detailed partition may benefit for the image quality. Therefore, the combined forced partition of QT and TT/AMP may be used. In the disclosed combination of a forced QT and a forced TT/AMP implementation, a forced TT/AMP partition is only done after a certain number of forced QT levels. In the forced TT/AMP and forced QT combined implementation, the number of forced QT levels could be pre-defined or adaptively selected. FIG. 9(a) illustrates the example of one level QT and with a forced TT terminated by a forced BT partitioning of 128×56 samples at the bottom boundary in 128×128 CTU. FIG. 8(b) illustrates the example of one level QT and with forced AMP terminated by forced BT partitioning of 128×56 samples bottom boundary in 128×128 CTU.

In general, TT of different art (uniform/non-uniform) or AMP of different art are also suitable for our forced TT/AMP+BT or combination of forced QT and forced TT/AMP+QT.

FIG. 10 is an illustration of a forced TT for HD bottom boundary partition with limited aspect ratio 1:4. In JEM software (after version 3.0), there is a definition of maximal BT size and a minimal BT size. For example, for Intra slice luma-component, the maximal BT size is 32 samples and the minimal BT size is 4 samples. When the long side of the current CU reach the maximal BT size or the short side of the current CU reach the minimal BT size, the current direction of BT split will be terminated. Instead, a normal directional BT split could be used. In other word, the maximal aspect ratio of previous CU is limited the BT splitting.

To make sure the further normal partition (non-forced, RDO based) has more freedom, the forced TT/AMP (+BT) partition could also be limited by aspect ratio of current leaf node. When the aspect ratio is larger than a threshold value, a normal directional forced TT/AMP(+BT) splitting will be used instead current forced partition. The threshold value may be pre-defined, calculated both in encoder and decoder side using the same method, for instance the threshold can be calculated based on the temporal ID of the frame or slice type, or transferred in bitstream and in the decoder parsed to indicate the limited aspect ratio. FIG. 10 shows one example of forced TT partition limited by aspect ratio 1:4.

The aspect ratio of the current leaf node of the coding unit is limited as a criteria for partition direction when the aspect ratio exceeds a threshold value. The threshold may be predefined, derived using a predefined method or it may be included in the bitstream.

With the principles described above a video encoding apparatus, or a computer program for generating an encoded bitstream is able to produce the bitstream. The bitstream includes encoded units and partition information indicating how the coding tree units are partitioned so that the corresponding decoder is able to decode the encoded bitstream.

In the above the methods have been discussed from an encoder point of view. At the decoder side, corresponding boundary partition processing will be performed on the boundary CTUs/CUs.

For the forced TT/AMP partition, a horizontal TT/AMP, depicted in FIGS. 7 and 8 respectively, will be used on the CTU/CU located on the bottom boundary until the right bottom samples of the boundary leaf nodes inside the slice/picture bottom boundary or the rest samples could be directly split by forced BT horizontally. Vertical TT/AMP (not shown) will be used on the CTU/CU located on the right boundary until the right bottom samples of the boundary leaf nodes inside the slice/picture right boundary or the rest samples could be directly split by BT vertically. The right bottom corner CTU/CU will be partitioned using QT until the right bottom samples of the boundary leaf node inside of the slice/picture boundary or the leaf nodes becoming right/bottom boundary case. Further partition is operated based on the decoded splitting flag.

For the forced TT/AMP partition, horizontal TT/AMP will be used on the CTU/CU located on the bottom boundary until the right bottom samples of the boundary leaf nodes inside the slice/picture bottom boundary or the rest samples could be directly split by forced BT horizontally. Vertical TT/AMP will be used on the CTU/CU located on the right boundary until the right bottom samples of the boundary leaf nodes inside the slice/picture right boundary or the rest samples could be directly split by BT vertically. The right bottom corner CTU/CU will be partitioned using QT until the right bottom samples of the boundary leaf node inside of the slice/picture boundary or the boundary leaf nodes becoming right/bottom boundary case. Further partition is operated based on the decoded splitting flag.

As explained above, the arrangements for image coding may be implemented in hardware, such as the video encoding apparatus or video decoding apparatus as described above, or as a method. The method may be implemented as a computer program. The computer program is then executed in a computing device.

The apparatus, such as video decoding apparatus, video encoding apparatus or any other corresponding image coding apparatus is configured to perform one of the methods described above. The apparatus comprises necessary hardware components. These may include at least one processor, at least one memory, at least one network connection, a bus and similar. Instead of dedicated hardware components it is possible to share, for example, memories or processors with other components or access at a cloud service, centralized computing unit or other resource that can be used over a network connection.

The image coding apparatus and the corresponding method have been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. An image coding apparatus, comprising:
at least one processor configured to:
determine that a coding unit of an image is located on an image boundary; and
in response to determining that the coding unit is located on the image boundary:
determine whether the image boundary divides the coding unit into two portions having different sizes or equal sizes;
perform a boundary partition processing on the coding unit, wherein the boundary partition processing comprises triple tree partitioning or asymmetric partitioning if the image boundary divides the coding unit into two portions having different sizes; and
perform a symmetric binary tree partition if the image boundary divides the coding unit into two portions having equal sizes.

2. The image coding apparatus of claim 1, wherein the at least one processor is further configured to hierarchically repeat partitioning on child coding units, which are located on the image boundary, partitioned from the coding unit until a deepest level boundary coding unit is entirely inside the image boundary.

3. The image coding apparatus of claim 1, wherein the coding unit is a coding tree unit.

4. The image coding apparatus of claim 3, wherein the at least one processor is further configured to perform N shallowest levels quad tree partitioning after determining that the coding unit is located on the image boundary, wherein N is an integer smaller than a number of partitioning hierarchy levels.

5. The image coding apparatus of claim 4, wherein the at least one processor is further configured to use a predefined N shallowest levels of quad tree partitions or derive N shallowest levels of quad tree partitions using a predefined method.

6. The image coding apparatus of claim 1, wherein the at least one processor is further configured to limit an aspect ratio of a current leaf node of the coding unit as a criteria for partition direction when an aspect ratio exceeds a threshold value.

7. The image coding apparatus of claim 6, wherein the at least one processor is further configured to use, as the threshold value, a predefined threshold or to derive the threshold using a predefined method.

8. The image coding apparatus according to claim 1, wherein the at least one processor is further configured to use quad-tree partitioning in each hierarchy level for a corner boundary coding unit.

9. The image coding apparatus according to claim 1, wherein the apparatus is an image encoding apparatus, and wherein the at least one processor is further configured to generate a bitstream including coded coding units and partitioning information indicating how the coding tree units are partitioned.

10. The image coding apparatus according to claim 9, wherein the at least one processor is further configured to further partition a deepest level boundary coding unit according to rate-distortion optimization.

11. The image coding apparatus according to claim 1, wherein the apparatus is a decoding apparatus.

12. The image coding apparatus according to claim 11, wherein the apparatus is further configured to parse a bitstream including coded coding units and a partitioning information indicating how the coding tree units are partitioned.

13. The image coding apparatus of claim 3, wherein an indication of N shallowest levels of quad tree partitions or a threshold of an aspect ratio of the coding unit is obtained from partitioning information of the image.

14. A method for coding an image, comprising:
determining that a coding unit of an image is located on an image boundary; and
in response to determining that the coding unit is located on the image boundary:
determining whether the image boundary divides the coding unit into two portions having different sizes or equal sizes; and
if the image boundary divides the coding unit into two portions having different sizes, performing a boundary partition processing on the coding unit, wherein the boundary partition processing comprises triple tree partitioning or asymmetric partitioning; or
if the image boundary divides the coding unit into two portions having equal sizes, performing a symmetric binary tree partition.

15. The method according to claim 14, wherein the method further comprises hierarchically repeating partitioning on child coding units partitioned from the coding unit until a deepest level boundary coding unit is entirely inside the image boundary.

16. The method according to claim 14, wherein the coding unit is a coding tree unit.

17. The method according to claim 14, wherein the method further comprises performing N shallowest levels quad tree partitioning after determining that the coding tree unit is located on the image boundary, wherein N is an integer smaller than a number of partitioning hierarchy levels.

18. The method according to claim 14, wherein the method further comprises limiting an aspect ratio of a current leaf node of the coding unit as a criteria for partition direction when the aspect ratio exceeds a threshold value.

19. A computer program comprising program code configured to perform a method according to claim 14 when executed on a computing device.
